(19) United States
(12) Patent Application Publication
(10) Pub. No.: US 2010/0092078 A1
(43) Pub. Date: Apr. 15, 2010

(54) IMAGE PROCESSING APPARATUS AND METHOD

(75) Inventor: Naotsugu Sagawa, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/572,053

(22) Filed: Oct. 1, 2009

(30) Foreign Application Priority Data
Oct. 3, 2008 (JP) 2008-258538

(51) Int. Cl. G06K 9/34

(52) U.S. Cl. 382/164; 382/173

(57) ABSTRACT

An image processing apparatus segments a determination target image into regions, reads an image type determination condition that includes a plurality of object determination conditions concerning an object related to the region of the image from a storage device, and calculates a feature quantity of the segmented region. The image processing apparatus determines whether the segmented region satisfies at least one object determination condition that is included in the image type determination condition based on the plurality of object determination conditions included in the read image type determination condition and the calculated feature quantity of the region, and identifies an image type of the determination target image based on the region concerning the determination target image that is determined as satisfying the object determination condition.

### BACKGROUND OF THE INVENTION

1. Field of the Invention

The present invention relates to an image processing apparatus and an image type identification method.

2. Description of the Related Art

In automatically correcting an image, if a scene of the image can be determined, optimum correction can be performed or the amount of correction can be adjusted according to the scene. Thus, abetter result compared to what is obtained from the conventional correction can be obtained. For example, if an image is determined to be a scene of blue sky, a good blue sky image can be obtained by correcting a blue portion of the image to bright blue according to a memory color of blue sky.

As a conventional technique for determining scenes, Japanese Patent Application Laid-Open No. 8-62741 discusses a technique for determining a backlight scene based on a luminance difference between adjacent regions of an image. Further, Japanese Patent Application Laid-Open No. 2005-293554 discusses a technique for determining a main object based on a color and a position of a region of the image.

However, the scene determined by the technique discussed in the above-described Japanese Patent Application Laid-Open No. 8-62741 is a scene that has distinctive brightness and the technique is not for determining a general scene.

Further, according to the technique discussed in the above-described Japanese Patent Application Laid-Open No. 2005-293554, if a blue region is in the upper portion of the image, the region is determined as a blue sky object even if it is small. Thus, the image is determined as an image including blue sky. Generally, an image of blue sky that can provide a good correction result when it is corrected is an image having an enough blue sky portion. Thus, the technique discussed in the above-described Japanese Patent Application Laid-Open No. 2005-293554 is not appropriate for automatically and accurately determining a scene (image type) that can produce a good image when the correction is made.

### SUMMARY OF THE INVENTION

The present invention is directed to an image processing apparatus that is capable of appropriately identifying an image type.

According to an aspect of the present invention, an image processing apparatus includes a region segmentation unit configured to segment a determination target image into regions, a reading unit configured to read, from a storage device, an image type determination condition including a plurality of object determination conditions concerning an object that is related to the region of the image, a calculation unit configured to calculate a feature quantity of the region segmented by the region segmentation unit, a region determination unit configured to determine whether the region segmented by the region segmentation unit satisfies at least one object determination condition that is included in the image type determination condition based on the plurality of object determination conditions included in the image type determination condition read by the reading unit and the feature quantity of the region calculated by the calculation unit, and an identification unit configured to identify an image type of the determination target image based on the region concerning the determination target image that is determined as satisfying the object determination condition by the region determination unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a hardware configuration of an image processing apparatus.

FIG. 2 is a flowchart illustrating an example of scene identification processing according to a first exemplary embodiment of the present invention.

FIG. 3A illustrates an original image and FIG. 3B illustrates an example of the image in FIG. 3A after its regions are segmented according to a clustering method.

FIG. 4 is a flowchart illustrating an example of region feature quantity calculation processing.

FIG. 5 illustrates an example of a scene profile according to the first exemplary embodiment of the present invention.

FIG. 6 illustrates an example of the scene profile.

FIG. 7 is an example of a color condition of an image that is described using HSV color space.

FIG. 8 illustrates an example of pixels of a portion of blue sky, which is taken from a typical blue sky image, represented in the HSV color space.

FIG. 9 illustrates an example of a color range of a blue sky color distribution in the HSV color space.

FIG. 10 is a flowchart illustrating detailed processing performed in step S2007.

FIGS. 11 and 12 are flowcharts illustrating detailed processing performed in step S2304.

FIG. 13 illustrates an example of a result of a scene determination.

FIG. 14 is a flowchart illustrating an example of image search processing according to a second exemplary embodiment of the present invention.

FIG. 15 illustrates an example of a user interface.

FIG. 16 is a flowchart illustrating an example of image search processing according to a third exemplary embodiment of the present invention.

FIG. 17 illustrates an example of acquisition processing for a region feature file.

FIG. 18 is a flowchart illustrating an example of scene identification processing and correction processing according to a fourth exemplary embodiment of the present invention.

FIG. 19 is an example of a table including scene and correction information.

FIG. 20 is a flowchart illustrating detailed processing performed in step S2902.

FIG. 21 is an example of a scene profile according to the fourth exemplary embodiment.

### DESCRIPTION OF THE EMBODIMENTS

Various exemplary embodiments, features, and aspects of the invention will be described in detail below with reference to the drawings.

According to a first exemplary embodiment of the present invention, conditions concerning a plurality of scenes (image types) are applied to one image so as to determine which scene corresponds to the image.

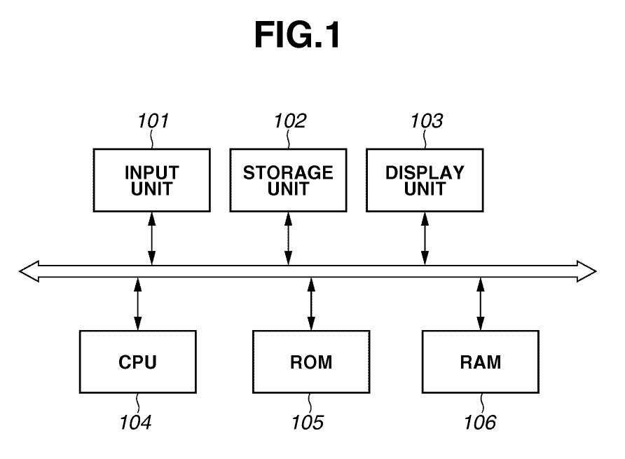

FIG. 1 illustrates an example of a hardware configuration of an image processing apparatus (computer). In FIG. 1, an input unit 101 includes a keyboard and a pointing device. A user operates the input unit 101 to input data and make instructions. A storage unit 102 is configured to store binary data and metadata. The storage unit 102 is, for example, a hard disk. A display unit 103 displays the binary data stored in the storage unit 102. The display unit 103 is, for example, a cathode ray tube (CRT) display or a liquid crystal display.

A CPU 104 is configured to control all of the above-described processing. A ROM 105 and a RAM 106 provide memory and a working area necessary in the processing. Each processing of the flowcharts described below is implemented by the CPU 104 reading out a program from the ROM 105 and executing processing based on the program.

Further, in addition to the components from the input unit 101 to the RAM 106 described above, the image processing apparatus may include a reading unit that reads an image from an image capture apparatus that includes a publicly-known CCD element.

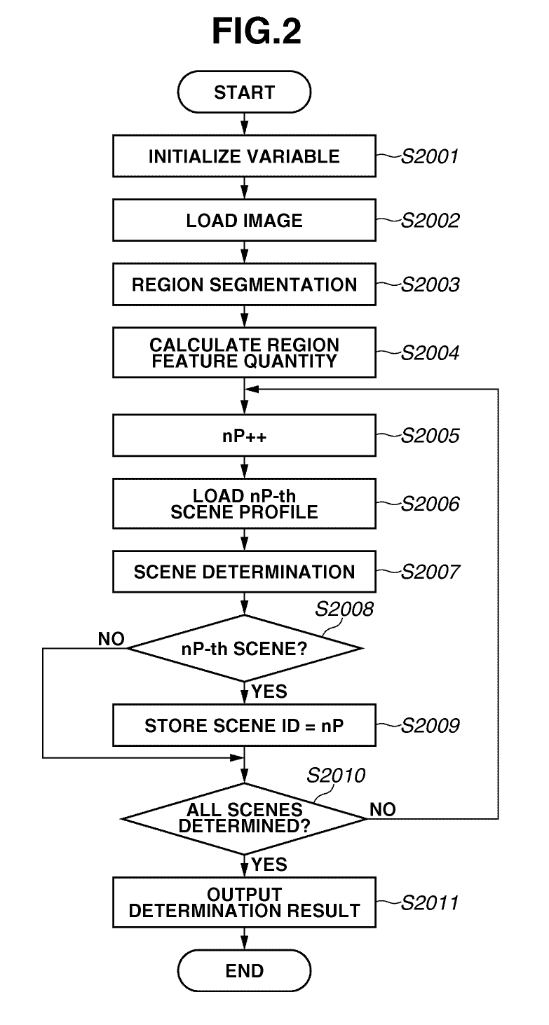

FIG. 2 is a flowchart illustrating an example of scene identification processing according to the first exemplary embodiment.

In step S2001, the CPU 104 initializes a variable nP to 0. The variable nP is a loop variable that the CPU 104 uses when the CPU 104 references a condition file used for determining a plurality of scenes in order. In step S2002, the CPU 104 loads image data, which is a target for scene determination, into the RAM 106. In step S2003, the CPU 104 performs region segmentation of the image loaded in step S2002.

Regarding the region segmentation method, an arbitrary method can be used so long as an image can be segmented into regions according to its feature such as color. For example, the technique discussed in Japanese Patent Application Laid-Open No. 2000-090239 can be used as an edge extraction method and the technique discussed in Japanese Patent Application Laid-Open No. 08-083339 can be used as a region expansion method. However, a clustering method discussed in Japanese Patent Application Laid-Open No. 2001-43371 will be used according to the present embodiment.

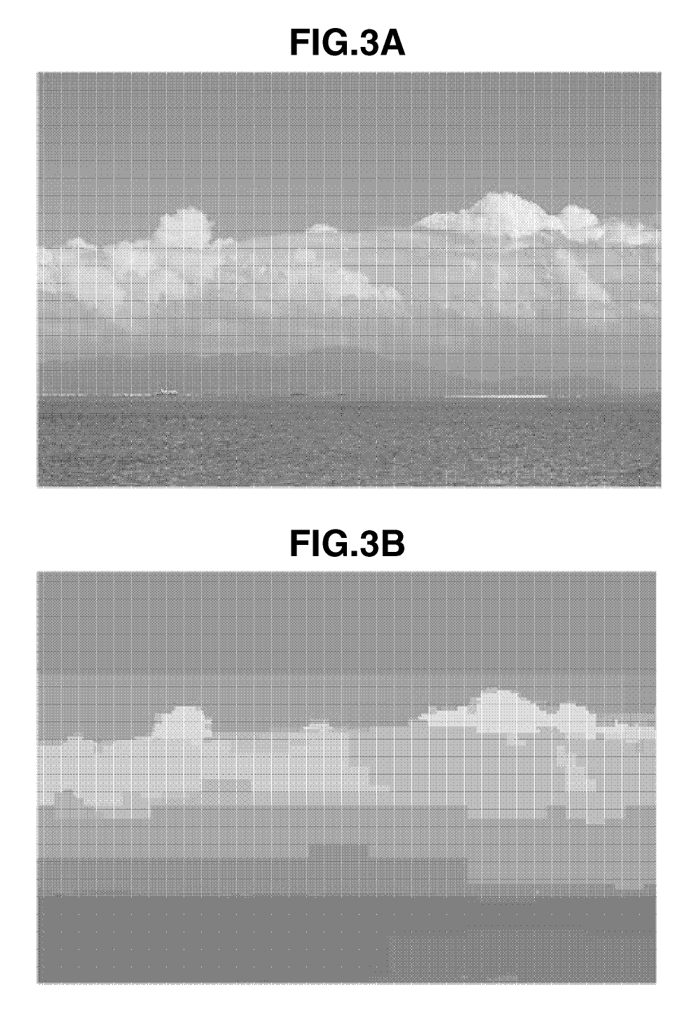

FIG. 3A illustrates an original image and FIG. 3B illustrates an example of the image after its regions are segmented using the clustering method.

In step S2004, the CPU 104 calculates the feature quantities of the regions segmented in step S2003.

Since the feature quantities of a region that are necessary in determining the scene are area, average color, and position (position information) of the region, the CPU 104 calculates these feature quantities.

According to the present embodiment, the CPU 104 calculates the number of pixels of each region as the area of the region, and calculates the proportion of the region to the whole image. Further, the CPU 104 calculates mean values aveR, aveG, and aveB, which are average colors of R, G, and B components of the region. Then, using the obtained values, the CPU 104 calculates the values that are converted into HSV format. Further, as a position of the region, the CPU 104 calculates center of gravity values (Cx, Cy) from coordinates of each pixel in the region, and then calculates the proportion of the region in the horizontal and vertical directions.

Next, as an example of a calculation method for the feature quantities, a case where the CPU 104 outputs a list of region IDs (ID map) based on the result of the region segmentation processing, and calculates the feature quantities using the ID map will be described.

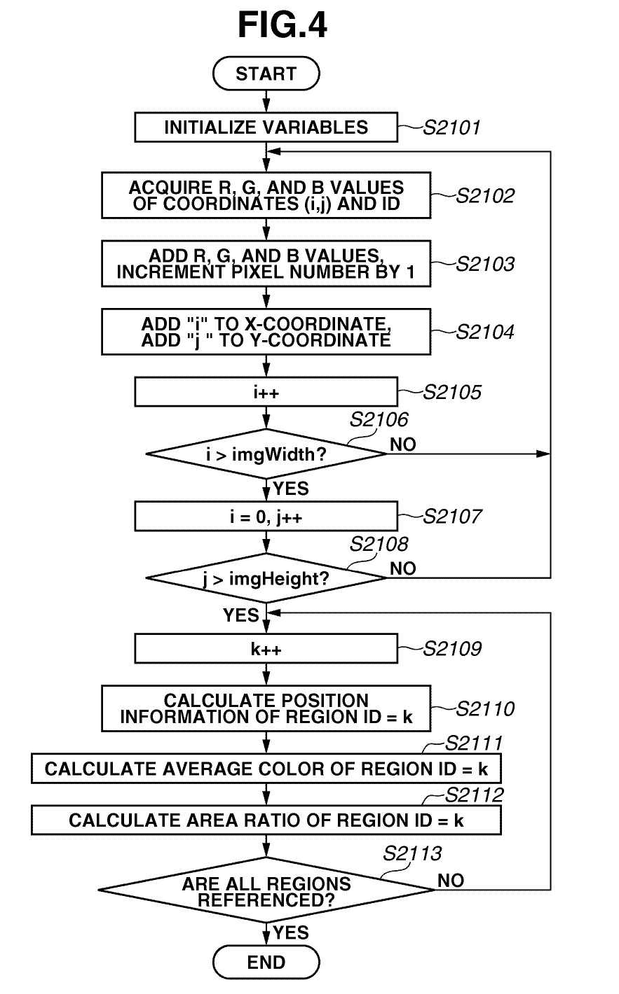

FIG. 4 is a flowchart illustrating an example of the calculation processing for the region feature quantities.

In step S2101, the CPU 104 initializes variables i, j, and k to 0. The variable i is a loop variable that is used when the image is scanned in the X-axis direction. The variable j is a loop variable that is used when the image is scanned in the Y-axis direction. The variable k is a loop variable that is used when a region is referenced in order.

In step S2102, the CPU 104 acquires R, G, and B values of the coordinates (i, j) from the original image and an ID value from the ID map. The acquired ID value will be hereinafter referred to as “n” in the processing described below.

In step S2103, the CPU 104 increments sumR[n], sumG[n], and sumB[n], which are sum of the R, G, and B values where ID=n, by the R, G, and B values acquired from the original image in step S2102. Further, the CPU 104 increments the number of pixels numOfPixels[n], which is the number of pixels of ID=n, by 1.

In step S2104, the CPU 104 increments a sum of X coordinates sumX[n] and a sum of Y coordinates sumY[n], where ID=n, by the variables i and j, respectively.

In step S2105, the CPU 104 moves the target pixel in the X coordinate direction by 1.

In step S2106, the CPU 104 compares the variable i being the loop variable of the X coordinate with a width of the image imgWidth to determine whether the scanning in the X coordinate direction has been completed. If the scanning in the X coordinate direction has been completed, in other words, if the variable i is greater than the width of the image imgWidth (YES in step S2106), the process proceeds to step S2107. If the variable i is smaller than or equals the width of the image imgWidth (NO in step S2106), then the process returns to step S2102.

In step S2107, the CPU 104 sets the variable i to 0 so as to set the target pixel at the head of the line, and then increments the variable j by 1.

In step S2108, the CPU 104 compares the variable j being the loop variable of the Y coordinate with a width of the image imgHeight to determine whether the scanning in the Y coordinate direction has been completed. If the scanning in the Y coordinate direction has been completed, in other words, if the variable j is greater than the width of the image imgHeight (YES in step S2108), the process proceeds to step S2109. If the variable j is smaller than or equals the height of the image imgHeight (NO in step S2108), then the process returns to step S2102.

In step S2109, the CPU 104 increments the variable k by 1.

In step S2110, the CPU 104 calculates a position of the region where ID=k as a proportion in the X-axis direction and in the Y-axis direction. First, the CPU 104 calculates center of gravity coordinates (Cx[k], Cy[k]) using the sum values sumX[k] and sumY[k] of the X and Y coordinates and the numOfPixels[k] being the number of pixels of the region. The CPU 104 calculates the center of gravity coordinates Cx[k] and Cy[k] according to the following formulae:

Cx[k]=sumX[k]/numOfPixels[k]

Cy[k]=sumY[k]/numOfPixels[k]

Next, the CPU 104 calculates values Rx[k] and Ry[k] being the proportion of the position according to the height, the width, and the center of gravity values of the image according to the following formulae:

Rx[k]=Cx[k]/imgWidth

Ry[k]=Cy[k]/imgHeight

In step S2111, the CPU 104 calculates average color component values aveH[k], aveS[k], and aveV[k] where ID=k. First, the CPU 104 calculates the mean values of R, G, and B according to the following formulae:

aveR[k]=sumR[k]/numOfPixels[k]

aveG[k]=sumG[k]/numOfPixels[k]

aveB[k]=sumB[k]/numOfPixels[k]

Then, the CPU 104 converts the mean values into HSV values.

In step S2112, the CPU 104 calculates a ratio Rs[k] being the ratio of an area of a region of ID=k to the area of the whole image according to the following formula:

Rs[k]=numOfPixels[k]/TotalPixels

The value TotalPixels is the number of pixels of the whole image.

In step S2113, the CPU 104 compares the loop variable k with the total number of regions nR to determine whether the feature quantities of all the regions are calculated. If the feature quantities of all the regions are calculated, in other words, if the variable k is greater than the total number of regions nR (YES in step S2113), then the process in FIG. 4 ends. If the variable k is smaller or equals the total number of regions nR (NO in step S2113), then the process returns to step S2109.

Referring now back to FIG. 2, in step S2005, the CPU 104 increments the variable nP by 1. In step S2006, the CPU 104 loads a scene determination condition (scene profile) which has been prepared in advance. This is called image type determination condition loading.

The description of the scene profile will now be given in detail.

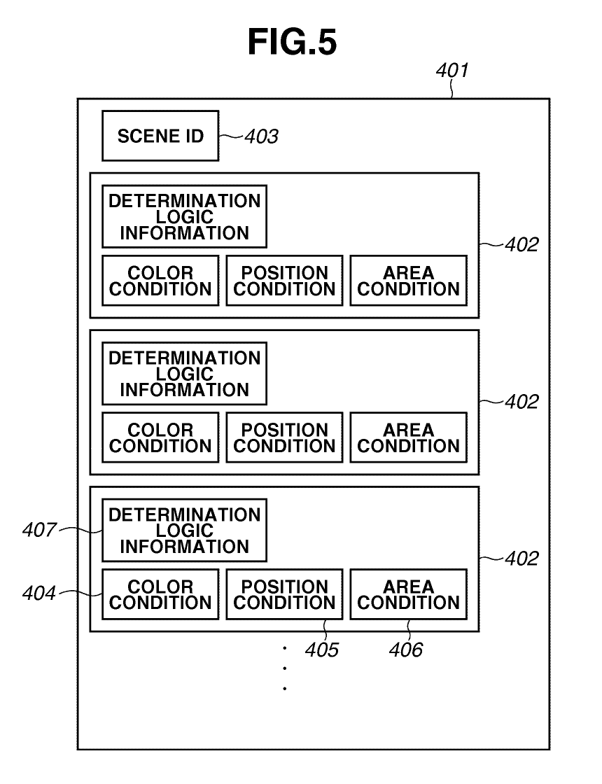

FIG. 5 illustrates an example of a scene profile according to the first exemplary embodiment.

According to the present embodiment, the CPU 104 determines a scene according to a combination of objects that are included in an image. The object according to the present embodiment is a region of an image, and has a distinctive color, position, or area.

A scene profile 401 illustrated in FIG. 5 includes a scene ID 403 and an object determination condition (object profile) 402 regarding the object. As illustrated in FIG. 5, the scene profile 401, which is an example of the image type determination condition, includes a plurality of object profiles.

The object profile 402 includes a color determination condition 404, a position determination condition 405, an area determination condition 406, and determination logic information 407 about a determination logic of the object profile, all of which are used for determining a region of the image. The determination logic information 407 includes information by which a determination logic is selected. More particularly, according to the determination logic information 407, if a region that satisfies the condition of the object profile exists, then the determination logic, which determines that the object profile is satisfied, is selected. If such a region does not exist, then the determination logic, which determines that the object profile is not satisfied, is selected.

Thus, according to the former determination logic, the CPU 104 can determine an image that includes an intended object. According to the latter determination logic, the CPU 104 can determine an image that does not include the intended object. According to the present embodiment, to simplify the description, a case where the former determination logic is used will be described.

Each determination condition regarding color, position, and area will be described below in detail.

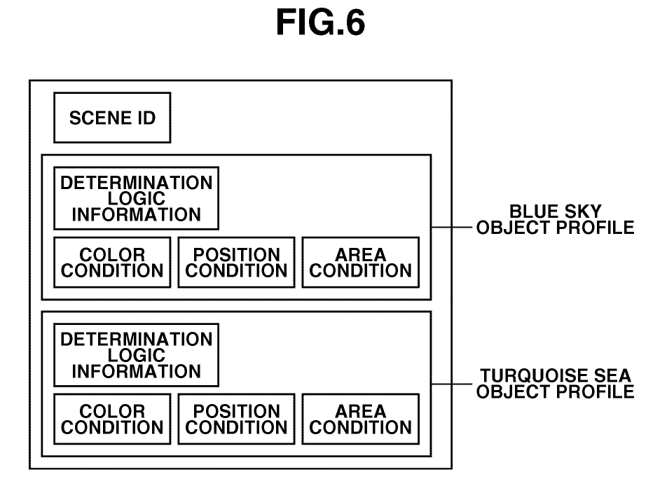

Next, description of a condition of a scene profile according to the present embodiment will be described using a “scene of blue sky and turquoise sea” as an example. FIG. 6 illustrates an example of a scene profile of a “scene of blue sky and turquoise sea”.

In the “scene of blue sky and turquoise sea”, the objects that constitute the scene are “blue sky” and “turquoise sea”. Thus, as illustrated in FIG. 6, the scene profile includes a “blue sky object profile” and a “turquoise sea object profile”.

Next, a description method of a condition of the object profile will be described.

[Color Condition Description Method]

The color condition is described using a maximum value and a minimum value of each axis in the color space.

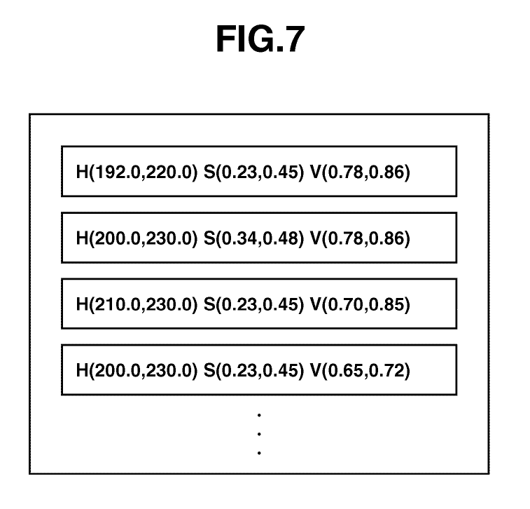

FIG. 7 is an example of a color condition of an image that is represented in the HSV color space. A maximum value and a minimum value are set for each of the H, S, and V components. When a complicated color range is represented in the color space, a plurality of sets of H, S, and V components can be used.

Although the HSV color space is used according to the present embodiment, RGB color space, HLS color space, or other arbitrary color space can also be used. Further, although only the color determination condition based on the HSV color space is used according to the present embodiment, a plurality of color spaces can also be used in making the color determination. In this case, color space identification information that includes a correspondence between a color determination condition and a color space that defines the color determination condition will be included in the object profile. Then, the CPU 104 can make the color determination according to the color space identification information.

A concrete example of how a color determination condition of an intended object is determined will be described below.

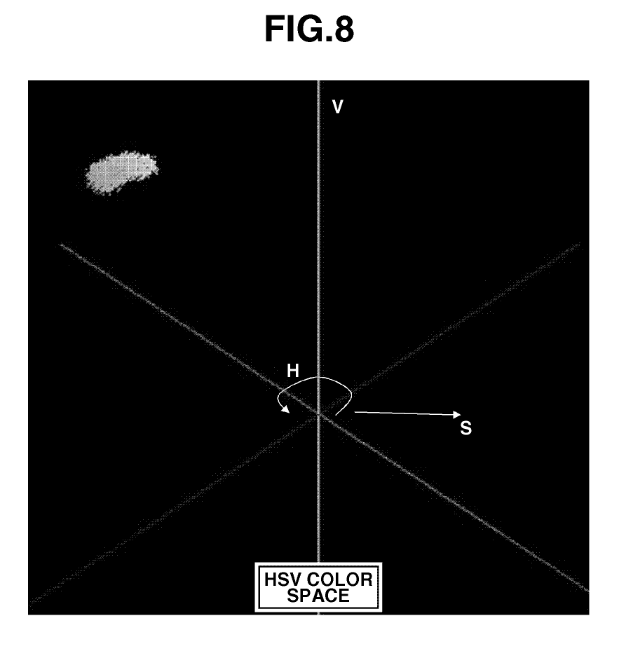

A method for determining a color determination condition from an image will now be described taking an example of “blue sky” as the intended object. First, from an image including typical blue sky, pixels of the portion of the blue sky are represented in the HSV color space (see FIG. 8).

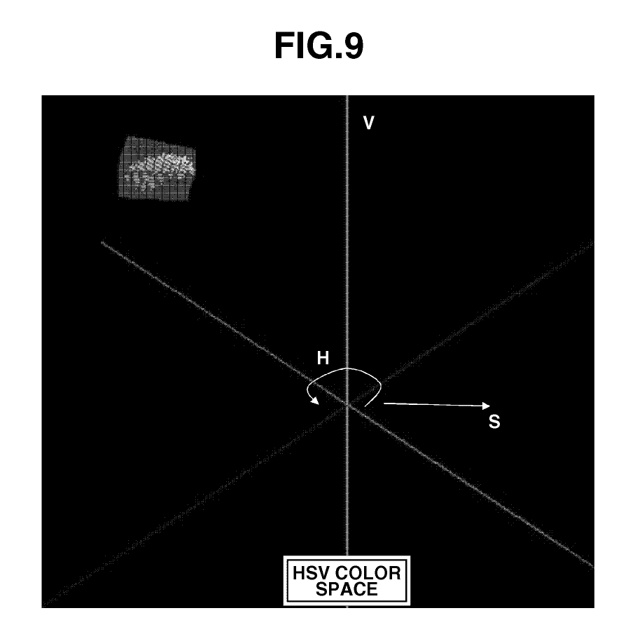

Next, the range of each axis is adjusted so that the color distribution is covered in the color space. As illustrated in FIG. 9, a three-dimensional object that is formed by planes that correspond to the range of each axis is displayed in the color space. By matching an adjustment degree of the range of each axis with the three-dimensional shape in the color space, a range of each axis that covers the color distribution can be easily determined.

Although a single three-dimensional object covers the color distribution in FIG. 9, if the shape of the color distribution in the color space is complicated, the color distribution can be covered by a plurality of three-dimensional objects. In this case, a plurality of sets of the color range of each axis will be used.

[Position Condition Description Method]

The position condition is described using a maximum value and a minimum value of the coordinates in the vertical direction and the horizontal direction of the image.

The following positional information is an example where the maximum and the minimum values of the coordinates are given in proportion to the vertical length (Y-axis direction) and the horizontal length (X-axis direction) of the image. X(0.0, 1.0) Y(0.0, 0.5)

According to this example, the coordinate in the X-axis direction ranges from 0.0 to 1.0 and the coordinate in the Y-axis direction ranges from 0.0 to 0.5. Thus, the condition will be determined as that used for determining an object that is in the upper half portion of the image (a case where the upper left corner is defined as a point of origin of the coordinates).

[Area Condition Description Method]

The area condition is described using a maximum value and a minimum value of the area of the region of the image.

The following example gives conditions by expressing a ratio of the area of the region to the area of the whole image. S(0.12, 0.45)

The area condition of this example is for determining a region that has an area ratio of 12% to 45% with respect to the entire image.

The number of object profiles that are included in the scene profile and the number of color determination conditions included in each object profile are included in the scene profile since they are necessary when the CPU 104 loads the scene profile.

The form of the condition description is not a principal object of the present embodiment. Thus the condition can be described in any form so long as the color determination condition, the position determination condition, and the area determination condition can be described. Thus, as is with the present embodiment, the condition can be expressed in a comma separated values or described in a binary form or in XML format.

Referring back again to FIG. 2, in step S2006, the CPU 104 loads an i-th scene profile. At this time, the CPU 104 acquires the number of object profiles included in the scene profile.

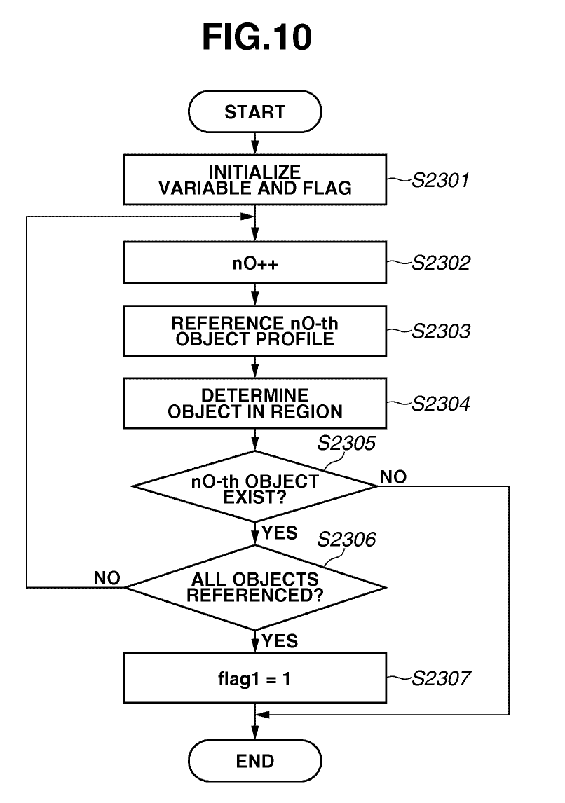

In step S2007, the CPU 104 determines the scene based on the determination condition of the scene profile loaded in step S2006. FIG. 10 is a flowchart illustrating detailed processing performed in step S2007.

In step S2301, the CPU 104 initializes the variable nO and a flag 1 to 0. The variable nO is a loop variable that is used when the object profiles included in the i-th scene profile are referenced in order. The flag 1 indicates whether the description condition of the i-th scene profile is satisfied. If the description condition is satisfied, then flag 1=1 will be set. If not, flag 1=0 will be set.

In step S2302, the CPU 104 increments the variable nO by 1.

In step S2303, the CPU 104 references an nO-th object profile included in the scene profile that is loaded in step S2006.

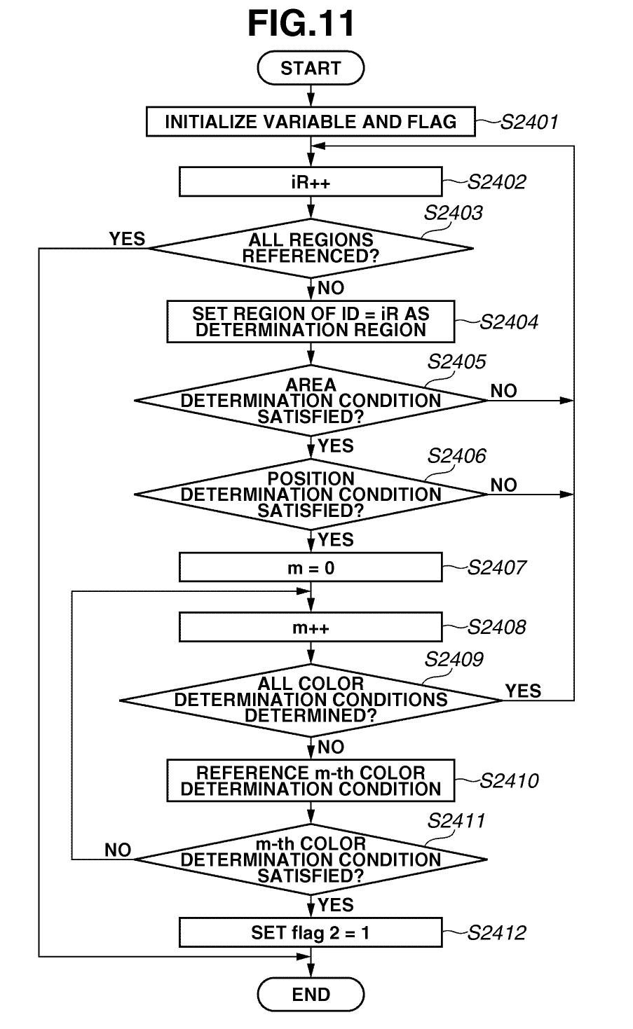

In step S2304, the CPU 104 performs object determination of the region (region determination) based on the determination condition that has been referenced in step S2303 and the region feature quantities that have been calculated in step S2004. FIG. 11 is a first flowchart illustrating detailed processing performed in step S2304.

In step S2401, the CPU 104 initializes a variable iR and a flag 2 to 0. The variable iR is a loop variable that is used when the regions in the image are referenced in order. The flag 2 indicates whether a region that satisfies the nO-th object profile exists. If such a region exists, then flag 2=1 will be set. If not, flag 2=0 will be set.

In step S2402, the CPU 104 increments the variable iR by 1.

In step S2403, the CPU 104 compares the variable iR, which is a loop variable that is used when the regions are referenced, and the value of the total number of regions nR to determine whether the object determination of all the regions has been completed. If the object determination of all the regions has been completed (YES in step S2403), in other words, if the variable iR is greater than the total number of regions nR, then the process ends. If the object determination of all the regions has not been completed (NO in step S2403), then the process proceeds to step S2404.

In step S2404, the CPU 104 sets the region of ID=iR as the determination region. In step S2405, the CPU 104 determines whether an area ratio Rs[iR] of the region of ID=iR calculated in step S2004 is within the range of the area ratio loaded in step S2303. If the area ratio is within the range, the CPU 104 determines that the area condition is satisfied (YES in step S2405), and the process proceeds to step S2406. If the area condition is not satisfied (NO in step S2405), then the process returns to step S2402.

In step S2406, the CPU 104 determines whether position ratios Rx[iR] and Ry[iR] of the region ID=iR that are calculated in step S2004 are within the range of the position ratios that are loaded in step S2303. If the position ratios are within the range, the CPU 104 determines that the position condition is satisfied (YES in step S2406), and the process proceeds to step S2407. If the position is not satisfied (NO in step S2406), then the process returns to step S2402.

Next, the CPU 104 determines the color. Regarding the color determination condition, as described above, one object profile may have a plurality of determination conditions. In such a case, the CPU 104 determines that the color determination condition is satisfied if at least one determination condition of an average color of the region is satisfied.

Processing considering the color determination method will be described in step S2407 and onward.

In step S2407, the CPU 104 initializes a variable m to 0. The variable m is used when a plurality of color determination conditions in the object profile are referenced in order.

In step S2408, the CPU 104 increments the variable m by 1.

In step S2409, the CPU 104 determines whether all the color determination conditions included in the object profile are determined. If the CPU 104 determines that all the color determination conditions are determined (YES in step S2409), then the process returns to step S2402. If the CPU 104 determines that all the color determination conditions are not yet determined (NO in step S2409), then the process proceeds to step S2410. The number of color determination conditions included in an object profile is included in the scene profile in advance, and the CPU 104 references the value before the determination.

In step S2410, the CPU 104 references an m-th color determination condition.

In step S2411, the CPU 104 determines whether the average values aveH[iR], aveS[iR], and aveV[iR] of an color of the region ID=iR that is calculated in step S2004 are within the range of the m-th color determination condition referenced in step S2410. If the average values are within the range (YES in step S2411), the process proceeds to step S2412. If the average values are not within the range (NO in step S2411), then the process returns to step S2408.

In step S2412, the CPU 104 sets the flag 2 to 1, and then the process in FIG. 11 ends.

According to the present embodiment, if one region that satisfies the object profile determination condition exists in the image region, then the process of the object determination ends. However, object determination of all regions can also be performed. In this case, the CPU 104 stores an ID of a region that is determined as an object, and uses it for partially correcting the object region after the scene is determined.

Further, regarding the area determination method, if the CPU 104 divides an image into regions having a certain area such as blue sky or sea, the regions can be determined according to the area as is illustrated in FIG. 11. However, if the CPU 104 divides an object region into regions of a small area, for example, trees or lawn, then the regions may not be determined properly as they are too small.

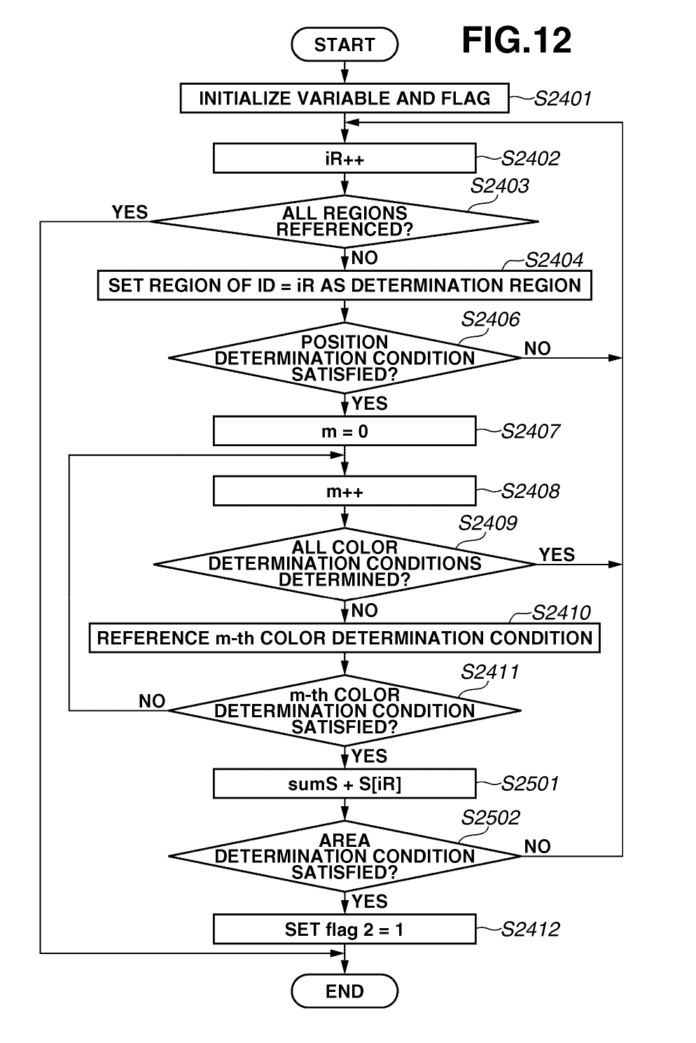

Thus, the CPU 104 does not make the determination according to the area of the region, and acquires a total area of the regions that satisfy the color and position conditions, and then determines the area according to the total area of the regions. The flow of the processes is illustrated in FIG. 12. FIG. 12 is a flowchart illustrating step S2304 in detail. The processes that are similar to those in FIG. 11 are denoted by the same process numbers and their descriptions are not repeated.

In step S2501, the CPU 104 increments a value sumS by an area S[iR] of the iR-th region. The value sumS is an increment value of an area of a region that satisfies the position and color conditions.

In step S2502, the CPU 104 determines the area. First, the CPU 104 calculates a ratio of incremented area Rss of the incremented area based on an increment value sumS and the number of pixels of the whole image. Then, the CPU 104 determines whether the ratio of the incremented area Rss is within the range of the area ratio that is loaded in step S2303. If the ratio of the incremented area is within the range, then the CPU 104 determines that the condition is satisfied (YES in step S2502), and the process proceeds to step S2412. If the ratio of the incremented area is not within the range (NO in step S2502), then the process returns to step S2402.

If both the method that determines an area by determining each area of the region which is described referring to FIG. 11 and the method that determines an area by determining the total area of the regions which is described referring to FIG. 12 are used, then the region determination methods will be included in the object profile. Then, the CPU 104 can select the appropriate determination method from the determination methods.

Now, referring back to FIG. 10, in step S2305, the CPU 104 references the value of the flag 2 that is determined in step S2304, and determines whether an nO-th object profile exists in the target image. If flag 2=1, the CPU 104 determines that the nO-th object profile exists (YES in step S2305), and the process proceeds to step S2306. If flag 2=0, the CPU 104 determines that the nO-th object profile does not exist. In other words, the CPU 104 determines that the scene is not the i-th scene profile (NO in step S2305), and the process in FIG. 10 ends, which also means that the process in step S2007 of FIG. 2 ends. Then, the process proceeds to step S2008.

In step S2306, the CPU 104 determines whether all the object profiles included in the i-th scene profile are referenced. If the CPU 104 determines that all the object files are referenced (YES in step S2306), the process proceeds to step S2307. In step S2307, the CPU 104 sets flag 1=1 and the processing in FIG. 10 ends. If the CPU 104 determines that all the object files are not referenced (NO in step S2306), then the process returns to step S2302.

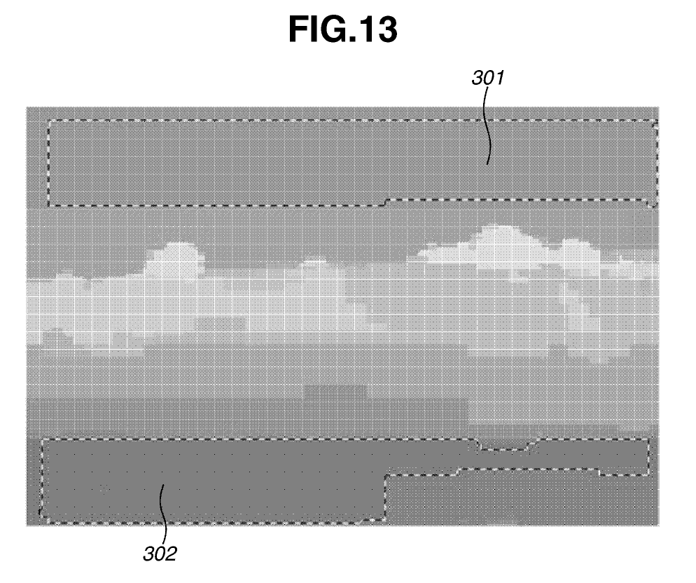

Now, referring back again to FIG. 2, in step S2008, the CPU 104 determines whether the scene is an nP-th scene based on the value of the flag 1 that is determined in step S2007. If flag 1=1, then the CPU 104 determines that the target image is the nP-th scene (YES in step S2008), and the process proceeds to step S2009. For example, if the image illustrated in FIG. 3A is determined by a “scene profile of blue sky and turquoise sea”, the CPU 104 determines that a region 301 in FIG. 13 is a blue sky object, and determines that a region 302 is a turquoise sea object. As a result, the CPU 104 determines that the image in FIG. 3A is a “scene of blue sky and turquoise sea”.

In step S2008, if flag 1=0, in other words, if the scene is determined not as the nP-th scene (NO in step S2008), then the process proceeds to step S2010.

In step S2009, the CPU 104 stores the variable nP as the ID of the scene concerned.

In step S2010, the CPU 104 compares the loop variable nP which is used when the scene profile is referenced and a value of the total number of scenes nSc to be determined to determine whether all the scene profiles are referenced. If all the files are referenced, in other words, if the variable nP is greater than the total number of scenes nSc (YES in step S2010), the process proceeds to step S2011. If all the files are not yet referenced (NO in step S2010), then the process returns to step S2005.

The CPU 104 gives a predetermined value to the total number of scenes nSc when the variable nP is initialized in step S2001.

In step S2011, the CPU 104 references the scene ID stored in step S2009 and outputs a scene that matches the target image to be determined. Since a table including the scene IDs and the scene names are prepared in advance, the CPU 104 can output a scene name by referring to the table and the scene ID stored in step S2009.

As described above, according to the present embodiment, the scene determination is performed using a scene profile, which uses the color and the position of the region as well as a combination of the color and the position with the area and, further, with other regions. Thus, the scene can be accurately determined. Additionally, if determination of a new scene is desired, it is possible by simply adding a scene profile.

A plurality of scene profiles can be prepared for one scene. In other words, the scene IDs in FIGS. 5 and 6 can overlap. According to the present embodiment, a scene of an image is determined if the scene matches any scene profile among a plurality of scene profiles having the same scene ID. Thus, the accuracy of the scene determination can be improved by adding a scene profile at a later time.

Further, according to the present embodiment, the scene determination condition is stored in a file format, and the determination condition is acquired by loading the file. However, the determination condition can be stored in the ROM or included in a program in advance.

Furthermore, according to the present embodiment, a scene profile is applied to a region that is segmented along the object shape. However, a scene profile may also be applied to a region that is obtained by segmenting an image into blocks having a predetermined size.

According to the first exemplary embodiment, a scene is determined by using a plurality of scene profiles for one image. According to a second exemplary embodiment of the present invention, a scene is determined by using one scene profile for a plurality number of images. According to the configuration described in the second exemplary embodiment, an image of an intended scene can be searched from a plurality of images. In other words, image search can be performed.

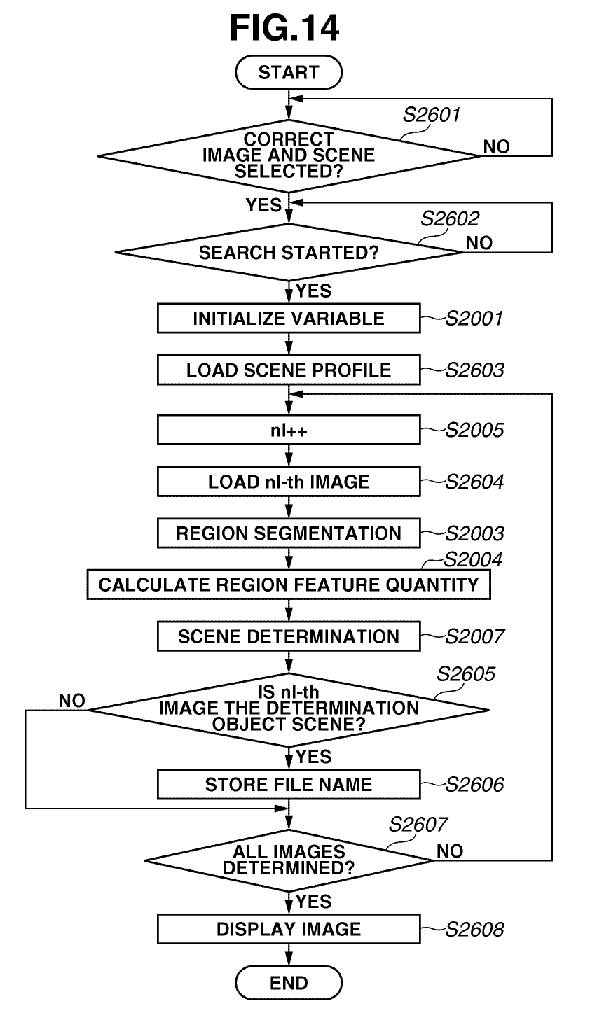

FIG. 14 is a flowchart illustrating an example of image search processing according to the second exemplary embodiment.

The processes that are similar to those in the first exemplary embodiment are denoted by the same process numbers and their descriptions are not repeated.

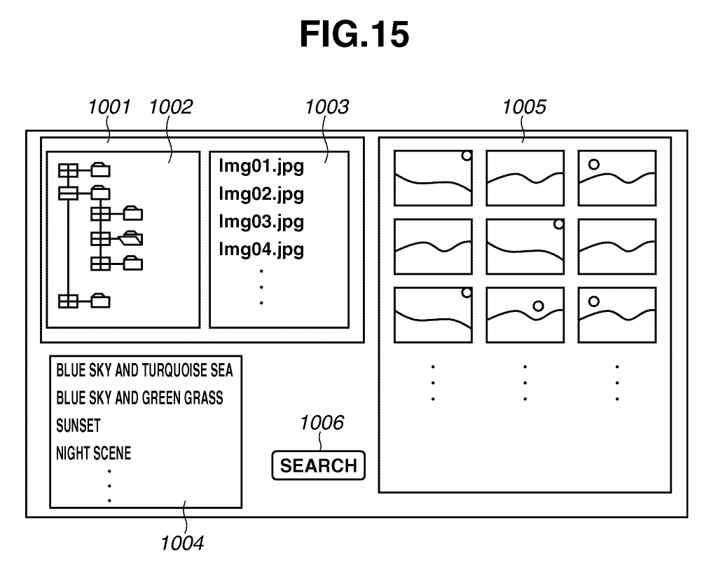

An example of a user interface that is used in realizing the present embodiment is illustrated in FIG. 15. FIG. 15 illustrates an example of a user interface.

In FIG. 15, a display area 1001 is where a search target image is displayed. According to the present embodiment, a folder tree is provided in a display area 1002. The user selects a folder including the search target image from the display area 1002. A display area 1003 is where an image file name of a file in the selected folder is displayed. A display area 1004 is a region from which a scene that the user wants to search is selected. A display area 1005 is where the result of the search is displayed. According to the present embodiment, the obtained image is displayed in a thumbnail form. A search button 1006 is used in starting the search.

In step S2601, the CPU 104 determines whether a search target image is selected from the display area 1001, or more particularly, a folder is selected from the folder tree in the display area 1002, and also determines whether a scene is selected from the display area 1004. If both the image and the scene are selected (YES in step S2601), the process proceeds to step S2602. If either the image or the scene is not selected (NO in step S2601), then step S2601 is repeated. Further, in this step, the CPU 104 stores a number of selected images nImg.

In step S2602, the CPU 104 determines whether the search button 1006 is pressed. If the search button 1006 is pressed (YES in step S2602), the process proceeds to step S2001. If the search button 1006 is not pressed (NO in step S2602), then step S2602 is repeated.

In step S2603, the CPU 104 loads a scene profile that matches the scene selected from the display area 1004.

In step S2604, the CPU 104 loads an nI-th image from the images selected from the display area 1001.

In step S2605, the CPU 104 references the flag 1 that is determined in step S2007. If flag 1=1, in other words, if the nI-th image is determined as the determination target scene (YES in step S2605), the process proceeds to step S2606. In step S2606, the file name of the nI-th image is stored. On the other hand, if flag 1=0, in other words if the nI-th image is not determined as the determination target scene (NO instep S2605), then the process proceeds to step S2607.

In step S2607, the CPU 104 compares the loop variable nI used in the reference of the images with the value of the number of selected images nImg to determine whether scenes of all the images selected from the display area 1001 are determined. If the determination of all the images has been completed, in other words, if the variable nI is greater than the number of selected images nImg (YES in step S2607), the process proceeds to step S2608. If the variable nI is smaller than or equals the number of selected images nImg (NO in step S2607), the process returns to step S2005.

In step S2608, the CPU 104 displays a thumbnail of the image file, which has been stored in step S2606, in the display area 1005.

According to the present embodiment, one scene profile is selected. However, a plurality of scene profiles can be selected and searched. In this case, the CPU 104 displays a union of the result obtained from the search of each scene profile as the result of the search.

As described above, according to the present embodiment, a scene which is selected by the user can be exclusively selected from a plurality number of images by the scene determination.

According to the second exemplary embodiment, even if an image of a certain scene is searched from a set of images that has been used before for searching a different image, the region segmentation processing and the feature quantity calculation processing has been performed again.

According to a third exemplary embodiment of the present invention, as a variation of the second exemplary embodiment, the region segmentation processing and the feature quantity calculation processing are performed to all search target images in advance. Then, the obtained result is stored in a file (region feature file) that is related to the file name of the images. Next, an example of scene determination which is performed by using the region feature file will be described.

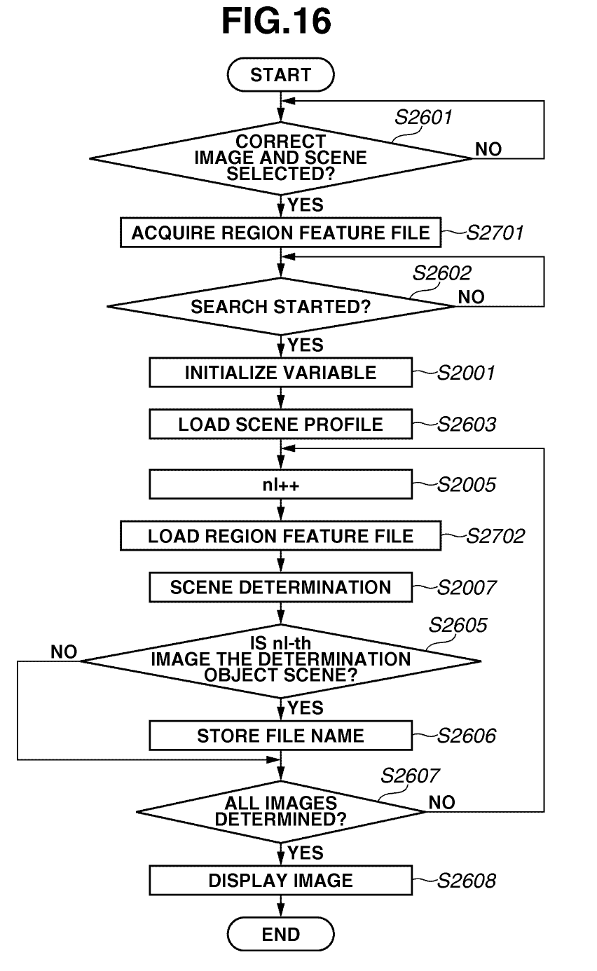

FIG. 16 is a flowchart illustrating an example of the image search processing according to the third exemplary embodiment.

The processes that are similar to those in the first and the second exemplary embodiments are denoted by the same process numbers and their descriptions are not repeated.

In step S2701, the CPU 104 acquires a region feature file that matches all the images selected in step S2601.

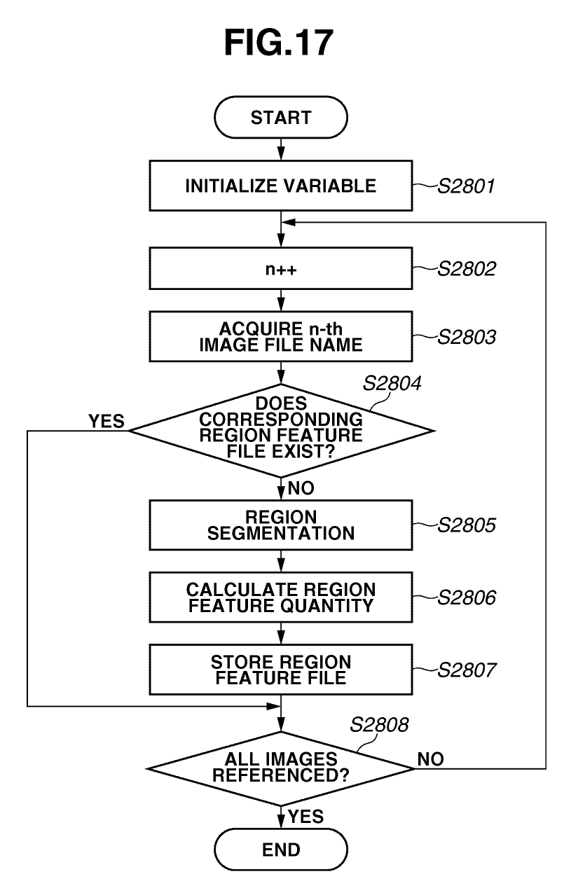

FIG. 17 illustrates an example of acquisition processing for a region feature file.

In step S2801, the CPU 104 initializes the variable n to 0. The variable n is a loop variable that the CPU 104 uses when it references the image files that are selected in step S2601 in order.

In step S2802, the CPU 104 increments the variable n by 1. In step S2803, the CPU 104 acquires an n-th image file name.

In step S2804, the CPU 104 determines whether a region feature file that corresponds to the image file name acquired in step S2803 exists (feature file existence determination). A region feature file is set in advance in the same folder with a file name that corresponds to the image file name. In this way, the CPU 104 can easily determine whether the intended region feature file exists by determining whether a region feature file that corresponds to the n-th image file name is included in the folder that is selected from the display area 1002. The CPU 104 can also set a folder in which the region feature files are stored in a collective manner, and determine the folder.

If the region feature file is determined to exist as a result of the determination (YES in step S2804), then the process proceeds to step S2808. If the region feature file is determined not to exist (NO in step S2808), the process proceeds to step S2805.

In step S2805, the CPU 104 performs the region segmentation processing for the n-th image file. Since the region segmentation processing is described in step S2003 of FIG. 2, detailed descriptions are not repeated.

In step S2806, the CPU 104 calculates a feature quantity of the region. Since the calculation method of the feature quantity is described in step S2004 of FIG. 2, detailed descriptions are not repeated.

In step S2807, the CPU 104 generates a feature quantity file based on the result of the region segmentation in step S2805 and the result of the feature quantity calculation in step S2806, and then stores the generated file.

In step S2808, the CPU 104 compares the loop variable n with the total number of images selected nImg to determine whether the scene determination of all the images selected from the display area 1001 has been completed. If all the images are determined, in other words, if the loop variable n is greater than the total number of images selected nImg (YES instep S2808), the process in FIG. 17 ends. If the loop variable n is smaller than or equals the total number of selected images nImg (YES instep S2808), then the process returns to step S2802.

Now, referring back to FIG. 16, in step S2702, the CPU 104 loads a region feature file that corresponds to the nI-th image file name.

According to the present embodiment, the same file name is used for the image file and the region feature file that corresponds to the image file. However, a relation between an image file name and a region feature file name can be managed via a known database.

According to the present embodiment, the region segmentation processing and the feature quantity calculation processing are performed for the search target image in advance, and the result is stored. This is useful when an image is searched and a different scene is searched later. This is because the result of the region segmentation processing and the feature quantity calculation processing obtained from the first search can be used for the second search. Accordingly, the processing time can be reduced.

According to a fourth exemplary embodiment of the present invention, the scene determination is performed using a scene profile, and optimum correction processing is performed according to the result of the determination.

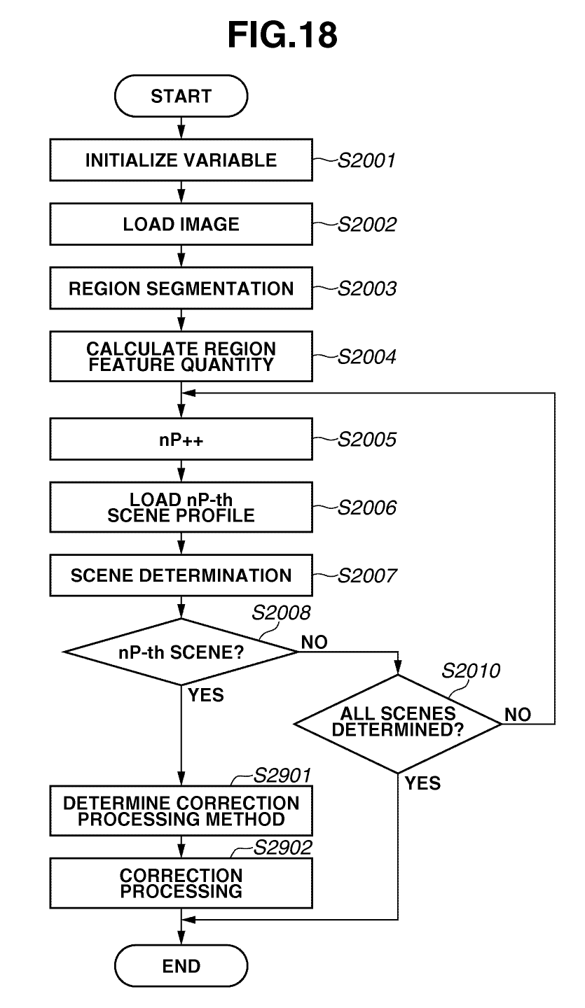

FIG. 18 is a flowchart illustrating an example of the scene identification processing and correction processing according to the fourth exemplary embodiment.

The processes that are similar to those in the first, the second, and the third exemplary embodiments are denoted by the same process numbers and their descriptions are not repeated.

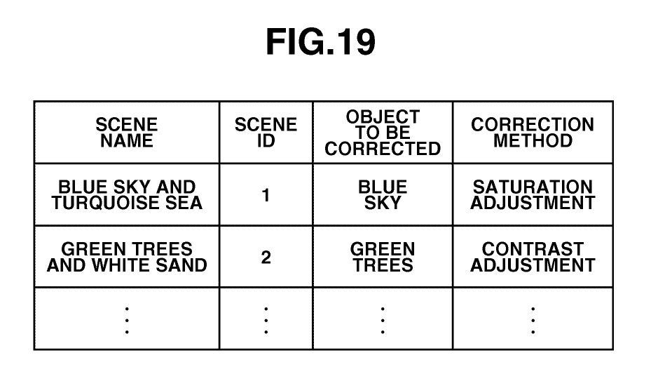

In step S2008, if the CPU 104 determines that the scene is the nP-th scene (YES in step S2008), the process proceeds to step S2901. In step S2901, the CPU 104 determines a correction processing method that is appropriate for the nP-th scene. The determination methods are prepared in advance in a table that includes scene and correction information as illustrated in FIG. 19. FIG. 19 is an example of a table including the scene and the correction information. Then, by referring to the table, the CPU 104 determines a correction processing method that is appropriate for the scene. According to the present embodiment, partial region correction is performed according to the scene. Thus, the table includes information about a correction object and a correction method.

By matching the variable nP and the scene ID in FIG. 19 in advance, the CPU 104 can acquire the correction information that matches the nP-th scene. The description below is based on a case where nP=1, in other words, the determination target image is determined as the scene of “blue sky and turquoise sea”.

According to FIG. 19, if nP=1, the blue sky object goes under saturation adjustment processing.

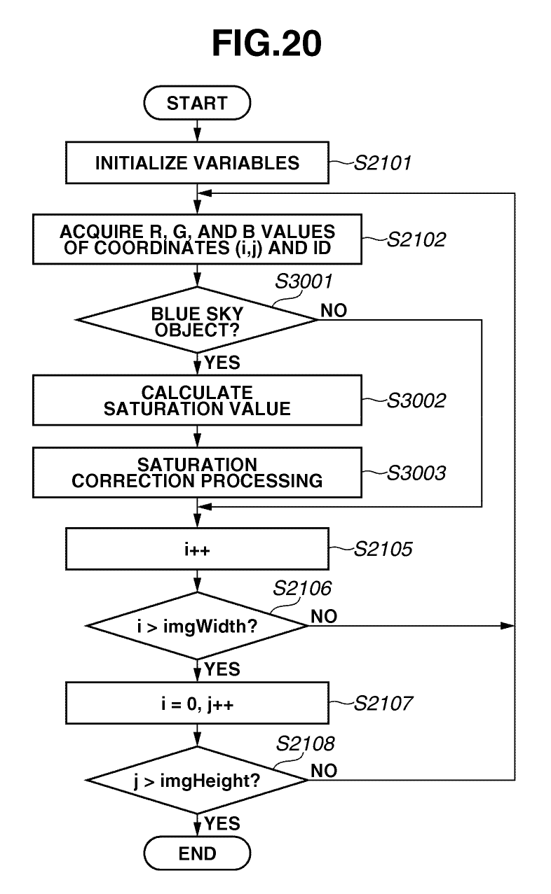

In step S2902, the CPU 104 adjusts the saturation of the blue object in the image. FIG. 20 is a flowchart illustrating detailed processing performed in step S2902. The processes in FIG. 20 that are similar to those in FIG. 4 are denoted by the same process numbers, and their descriptions are not repeated.

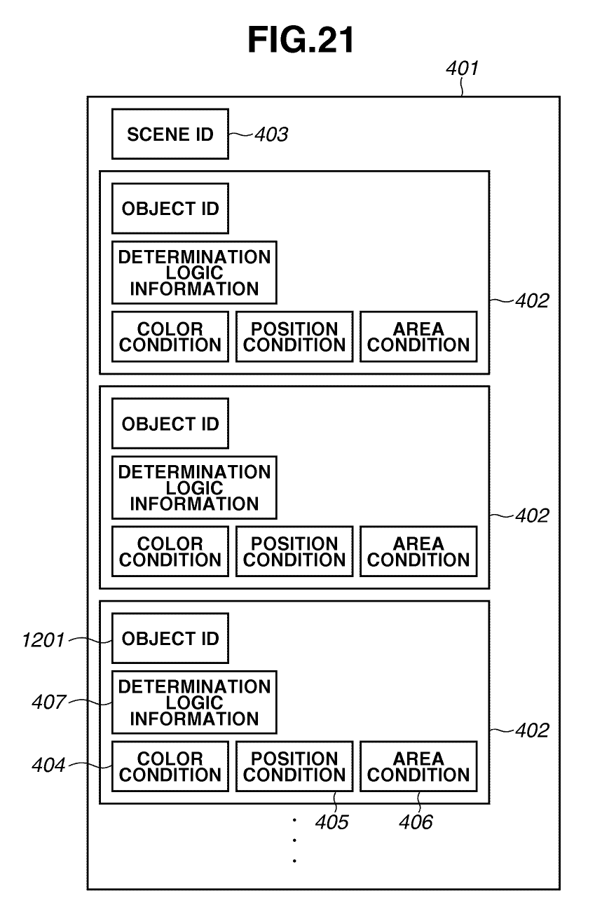

In step S3001, the CPU 104 determines whether the pixel of the coordinates (i, j) is included in the blue sky object. An object ID 1201, which is an identifier of the object, is included in the object profile 402 as illustrated in FIG. 21. The object ID can be used in determining the method. Then, as described in step S2304 in FIG. 10, if a region that satisfies the object condition exists when the object determination is performed, the CPU 104 stores the relation between the region ID and the object ID 1201. Then, the CPU 104 executes the determination by comparing the relation and the ID map. If the CPU 104 determines that the coordinates (i, j) are included in the blue sky object (YES in step S3001), the process proceeds to step S3002. If the CPU 104 determines that the coordinates (i, j) are not included in the blue sky object (NO in step S3001), the process proceeds to step S2105.

In step S3002, the CPU 104 calculates a saturation value from the pixel value of the coordinates (i, j).

Before calculating a saturation value S, the CPU 104 obtains Cb (chrominance blue) and Cr (chrominance red), and then calculates the saturation value S according to the following formulae:.

Cb=−0.1687*R−0.3312*G+0.5000*B

Cr=0.5000*R−0.4187*G−0.0813*B

S=\sqrt{Cb*Cb+Cr*Cr}

In step S3003, the CPU 104 adjusts the saturation of the pixel included in the blue sky object. The saturation can be adjusted by, for example, multiplying the saturation value S that is calculated in step S3002 by a predetermined ratio rS.

According to the present embodiment, if a scene is determined to be a certain scene, the scene determination processing ends and the process proceeds to the correction processing. However, since the CPU 104 can determine all the scenes, if a plurality of scenes are to be determined, the priority of the scenes will be determined in advance. Then, the scene of the highest priority will be able to go under appropriate correction processing. Further, the CPU 104 can perform all the correction processing that matches the determined scene.

Further, according to the present embodiment, a correction method and a correction object region are determined in advance according to the scene. However, a correction amount may be included as well.

According to the present embodiment, one object is partially corrected according to the scene. However, the CPU 104 can perform different processing or use different correction amount for a plurality of objects.

Further, according to the present embodiment, a pixel that is used when partial correction is performed is included in the pixels of the correction object. However, the CPU 104 can calculate, for example, an average color of a correction object and select a pixel, which is in the image, having a color similar to the average color, as the pixel to be used for the correction.

According to the present embodiment, since a scene of an image is determined, and then the correction processing is performed by determining the correction type or the amount of correction according to the result of the determination of the scene, optimum correction processing can be performed according to the scene.

According to the above-described exemplary embodiments, an image type of an image can be appropriately identified.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-258538 filed Oct. 3, 2008, which is hereby incorporated by reference herein in its entirety.

What is claimed is:

1. An image processing apparatus comprising:
a region segmentation unit configured to segment a determination target image into regions;
a reading unit configured to read, from a storage device, an image type determination condition including a plurality of object determination conditions concerning an object that is related to the region of the image;
a calculation unit configured to calculate a feature quantity of the region segmented by the region segmentation unit;
a region determination unit configured to determine whether the region segmented by the region segmentation unit satisfies at least one object determination condition that is included in the image type determination condition based on the plurality of object determination conditions included in the image type determination condition read by the reading unit and the feature quantity of the region calculated by the calculation unit; and
an identification unit configured to identify an image type of the determination target image based on the region concerning the determination target image that is determined as satisfying the object determination condition by the region determination unit.

2. The image processing apparatus according to claim 1, wherein the calculation unit calculates position information, an average color, and an area ratio of the region segmented by the region segmentation unit as feature quantities.

3. The image processing apparatus according to claim 1, further comprising a correction unit configured to correct the determination target image according to the image type identified by the identification unit.

4. An image processing apparatus comprising:
a selection unit configured to select a plurality of images being search targets and an image type according to a user operation;
a reading unit configured to read, from a storage device, an image type determination condition including a plurality of object determination conditions concerning an object related to a region of the image and relating to the image type selected by the selection unit;
a region segmentation unit configured to segment the image selected by the selection unit into regions;
a calculation unit configured to calculate a feature quantity of the region segmented by the region segmentation unit;
a region determination unit configured to determine whether the region segmented by the region segmentation unit satisfies at least one object determination condition that is included in the image type determination condition based on the plurality of object determination conditions included in the image type determination condition read by the reading unit and the feature quantity of the region calculated by the calculation unit; and
an identification unit configured to identify an image type of the image selected by the selection unit based on the region concerning the image that is determined as satisfying the object determination condition by the region determination unit.

5. An image processing apparatus comprising:
a selection unit configured to select a plurality of images being search targets and an image type according to a user operation;
a feature file existence determination unit configured to determine whether a feature file concerning a region of the image selected by the selection unit exists;
a generation unit configured to segment the image into regions, calculate the feature quantity of the segmented regions, and generate the feature file based on the result of the division and the calculated feature quantity, if the feature file is determined not to exist by the feature file existence determination unit;
a reading unit configured to read, from a storage device, an image type determination condition including a plurality of object determination conditions concerning an object that is related to the region of the image and relating to the image type selected by the selection unit;
a region determination unit configured to determine whether the region satisfies at least one object determination condition that is included in the image type determination condition based on the plurality of object determination conditions included in the image type determination condition read by the reading unit and the feature file generated by the generation unit; and
an identification unit configured to identify an image type of the image selected by the selection unit based on the region concerning the determination target image that is determined as satisfying the object determination condition by the region determination unit.

6. The image processing apparatus according to claim 4, further comprising:
an image type determination unit configured to determine whether the image type identified by the identification unit is the image type selected by the selection unit, and
an output unit configured to output, as a search result, information used for identifying an image whose image type that is identified by the identification unit is determined as the image type selected by the selection unit by the image type identification unit.

7. The image processing apparatus according to claim 1, wherein the object determination condition includes a position determination condition, a color determination condition, and an area determination condition, concerning the object.

8. An image type identification method for an image processing apparatus, the image type identification method comprising:
segmenting a determination target image into regions;
reading an image type determination condition, including a plurality of object determination conditions concerning an object that is related to the region of the image, from a storage device;
calculating a feature quantity of the segmented region;
determining whether the segmented region satisfies at least one object determination condition that is included in the image type determination condition based on the plurality of object determination conditions included in the read image type determination condition; and
identifying an image type of the determination target image based on the region concerning the determination target image determined as satisfying the object determination condition.

9. The image type identification method according to claim 8, further comprising calculating position information, an average color, and an area ratio of the segmented region as feature quantities.

10. The image type identification method according to claim 8, further comprising correcting the determination target image according to the identified image type.

11. An image type identification method for an image processing apparatus, the image type identification method comprising:
selecting a plurality of images being search targets and an image type according to a user operation;
reading, from a storage device, an image type determination condition that includes a plurality of object determination conditions concerning an object that is related to the region of the image and relates to the selected image type;
segmenting the selected image into regions;
calculating a feature quantity of the segmented region;
determining whether the segmented region satisfies at least one object determination condition that is included in the image type determination condition based on the plurality of object determination conditions included in the read image type determination condition and the calculated feature quantity; and
identifying an image type of the selected image based on the region concerning the image that is determined as satisfying the object determination condition.

12. An image type identification method for an image processing apparatus, the image type identification method comprising:
selecting a plurality of images being search targets and an image type according to a user operation;
determining whether a feature file concerning a region of the selected image exists;
segmenting the image into regions, calculating a feature quantity of the divided regions, and generating the feature file based on the result of the segmentation and the calculated feature quantity, if the feature file is determined not to exist;
reading, from a storage device, an image type determination condition that includes a plurality of object determination conditions concerning an object that is related to the region of the image and relates to the selected image type;
determining whether the region satisfies at least one object determination condition that is included in the image type determination condition based on the plurality of object determination conditions included in the read image type determination condition and the generated feature file; and
identifying an image type of the selected image based on the region concerning the determination target image that is determined as satisfying the object determination condition.

13. The image type identification method according to claim 11, further comprising:
determining whether the identified image type is the selected image type, and
outputting, as a search result, information used for identifying the image having the identified image type determined as the selected image type.

14. The image type identification method according to claim 8, wherein the object determination condition includes a position determination condition, a color determination condition, and an area determination condition concerning the object.

15. A computer-readable storage medium storing a program for instructing a computer to implement the image type identification method according to claim 8.

16. A computer-readable storage medium storing a program for instructing a computer to implement the image type identification method according to claim 11.

17. A computer-readable storage medium that storing a program for instructing a computer to implement the image type identification method according to claim 12.
